(19) United States
(12) Patent Application Publication
(10) Pub. No.: US 2024/0275526 A1
(43) Pub. Date: Aug. 15, 2024

(54) ENHANCEMENT OF HYBRID AUTOMATIC REPEAT REQUEST FEEDBACK

(71) Applicant: Nokia Technologies Oy, Espoo (FI)

(72) Inventors: Ugur Baran ELMALI, Munich (DE); David BHATOOLAUL, Swindon (GB); David NAVRÁTIL, Espoo (FI); Naizheng ZHENG, Beijing (CN); Volker PAULI, Munich (DE); Athul PRASAD, Naperville, IL (US)

(21) Appl. No.: 18/291,107

(22) PCT Filed: Aug. 6, 2021
(86) PCT No.: PCT/CN2021/111295

§ 371 Date: Jan. 22, 2024

(51) Int. Cl. H04L 1/1812; H04L 1/1867

(52) U.S. Cl. CPC H04L 1/1816; H04L 1/1893

(57) ABSTRACT

Example embodiments of the present disclosure relate to devices, methods, apparatuses and computer readable storage media for enhancement of HARQ feedback. The method comprises: upon receipt of data of at least one of a group of services from a second device, generating, at a first device, a Hybrid Automatic Repeat Request acknowledgement (HARQ-ACK) codebook comprising HARQ feedback and identification information for the at least one service, the group of services comprising at least one of multicast and broadcast services (MBSs) and unicast services; and transmitting the HARQ-ACK codebook to the second device. In this way, retransmissions of unicast and multicast services can be accurately scheduled in time, and unnecessary retransmissions can be avoided. In addition, the spectral efficiency and packet loss rate of the communication system can be improved.

### FIELD

Embodiments of the present disclosure generally relate to the field of telecommunication and in particular, to devices, methods, apparatus and computer readable storage media for enhancement of Hybrid Automatic Repeat Request (HARQ) feedback.

### BACKGROUND

To support Multicast and Broadcast services (MBSs) in 5G new radio (NR), the Point to Multi-Point (PTM) transmission is expected to efficiently provide MBSs to multiple users. This may be implemented by using the same radio framework as unicast transmission. Moreover, the service delivery between the network device (e.g., a gNB) and a terminal device (e.g., UE) in RRC_CONNECTED state can be facilitated by using frequency-division multiplexing (FDM) between a unicast transmission and a group-common multicast transmission on physical downlink shared channel (PDSCH).

Typically, terminal devices report whether data transmissions of MBS services are successfully received by application of various HARQ techniques. For example, an acknowledgement (ACK)/negative acknowledgement (NACK) based HARQ-ACK feedback, or a NACK-only based HARQ-ACK feedback is supported for PTM transmissions. It is important for the terminal device and its serving network to have the same understanding on the HARQ feedback that has been reported by the terminal device, for example, the content of a HARQ-ACK codebook, especially when multiple unicast/MBS services have been received by the terminal device and HARQ feedbacks for the multiple services are to be multiplexed in the same physical uplink control channel (PUCCH). Further, it can ensure that the serving network device can schedule retransmission of the data transmission of MBS services in time and accurately, even in a case where the terminal device has missed or failed to decode downlink control information (DCI) indicative of the MBS service to be transmitted on PDSCH.

### SUMMARY

In general, example embodiments of the present disclosure provide a solution for enhancement on the HARQ feedback.

In a first aspect, there is provided a first device. The first device comprises at least one processor; and at least one memory including computer program codes; the at least one memory and the computer program codes are configured to, with the at least one processor, cause the first device at least to: upon receipt of data of at least one of a group of services from a second device, generate a Hybrid Automatic Repeat Request acknowledgement (HARQ-ACK) codebook comprising HARQ feedback and identification information for the at least one service, the group of services comprising at least one of multicast and broadcast services (MBSs) and unicast services; and transmit the HARQ-ACK codebook to the second device.

In a second aspect, there is provided a second device. The second device comprises at least one processor; and at least one memory including computer program codes; the at least one memory and the computer program codes are configured to, with the at least one processor, cause the second device at least to: transmit, to a first device, data of a group of services comprising at least one of multicast and broadcast services (MBSs) and unicast services; and receive, from the first device, a Hybrid Automatic Repeat Request acknowledgement (HARQ-ACK) codebook comprising HARQ feedback and identification information for at least one of the group of services.

In a third aspect, there is provided a method. The method comprises: upon receipt of data of at least one of a group of services from a second device, generating, at a first device, a Hybrid Automatic Repeat Request acknowledgement (HARQ-ACK) codebook comprising HARQ feedback and identification information for the at least one service, the group of services comprising at least one of multicast and broadcast services (MBSs) and unicast services; and transmitting the HARQ-ACK codebook to the second device.

In a fourth aspect, there is provided a method. The method comprises: transmitting, at a second device and to a first device, data of a group of services comprising at least one of multicast and broadcast services (MBSs) and unicast services; and receiving, from the first device, a Hybrid Automatic Repeat Request acknowledgement (HARQ-ACK) codebook comprising HARQ feedback and identification information for at least one of the group of services.

In a fifth aspect, there is provided a first apparatus. The first apparatus comprises: means for upon receipt of data of at least one of a group of services from a second device, generating a Hybrid Automatic Repeat Request acknowledgement (HARQ-ACK) codebook comprising HARQ feedback and identification information for the at least one service, the group of services comprising at least one of multicast and broadcast services (MBSs) and unicast services; and means for transmitting the HARQ-ACK codebook to the second device.

In a sixth aspect, there is provided a second apparatus. The second apparatus comprises: means for transmitting, to a first device, data of a group of services comprising at least one of multicast and broadcast services (MBSs) and unicast services; and means for receiving, from the first device, a Hybrid Automatic Repeat Request acknowledgement (HARQ-ACK) codebook comprising HARQ feedback and identification information for at least one of the group of services.

In a seventh aspect, there is provided a computer readable medium having a computer program stored thereon which, when executed by at least one processor of a device, causes the device to carry out the method according to the third aspect.

In an eighth aspect, there is provided a computer readable medium having a computer program stored thereon which, when executed by at least one processor of a device, causes the device to carry out the method according to the fourth aspect.

Other features and advantages of the embodiments of the present disclosure will also be apparent from the following description of specific embodiments when read in conjunction with the accompanying drawings, which illustrate, by way of example, the principles of embodiments of the disclosure.

### BRIEF DESCRIPTION OF THE DRAWINGS

Embodiments of the disclosure are presented in the sense of examples and their advantages are explained in greater detail below, with reference to the accompanying drawings, where

FIG. 1 illustrates an example network system in which example embodiments of the present disclosure can be implemented;

FIG. 2 shows a signaling chart illustrating a process of measurement reporting mechanism according to some example embodiments of the present disclosure;

FIG. 3A illustrates a schematic diagram of an example data transmission between the terminal device and the network device according to some example embodiments of the present disclosure;

FIG. 3B illustrates a schematic diagram of an example HARQ-ACK codebook for the data transmission as shown in FIG. 3A according to some example embodiments of the present disclosure;

FIG. 4A illustrates a schematic diagram of an example data transmission between the terminal device and the network device according to some example embodiments of the present disclosure;

FIG. 4B illustrates a schematic diagram of an example HARQ-ACK codebook for the data transmission as shown in FIG. 4A according to some example embodiments of the present disclosure;

FIG. 5A illustrates a schematic diagram of an example data transmission between the terminal device and the network device according to some example embodiments of the present disclosure;

FIG. 5B illustrates a schematic diagram of an example HARQ codebook for the data transmission as shown in FIG. 5A according to some example embodiments of the present disclosure;

FIG. 6 illustrates a flowchart of an example method for reporting HARQ feedback according to some example embodiments of the present disclosure;

FIG. 7 illustrates a flowchart of an example method for reporting HARQ feedback according to some example embodiments of the present disclosure;

FIG. 8 shows a simplified block diagram of a device that is suitable for implementing example embodiments of the present disclosure; and

FIG. 9 shows a block diagram of an example computer readable medium in accordance with some embodiments of the present disclosure.

Throughout the drawings, the same or similar reference numerals represent the same or similar element.

### DETAILED DESCRIPTION

Principle of the present disclosure will now be described with reference to some example embodiments. It is to be understood that these embodiments are described only for the purpose of illustration and help those skilled in the art to understand and implement the present disclosure, without suggesting any limitation as to the scope of the disclosure. The disclosure described herein can be implemented in various manners other than the ones described below.

In the following description and claims, unless defined otherwise, all technical and scientific terms used herein have the same meaning as commonly understood by one of ordinary skills in the art to which this disclosure belongs.

References in the present disclosure to “one embodiment,” “an embodiment,” “an example embodiment,” and the like indicate that the embodiment described may include a particular feature, structure, or characteristic, but it is not necessary that every embodiment includes the particular feature, structure, or characteristic. Moreover, such phrases are not necessarily referring to the same embodiment. Further, when a particular feature, structure, or characteristic is described in connection with an example embodiment, it is submitted that it is within the knowledge of one skilled in the art to affect such feature, structure, or characteristic in connection with other embodiments whether or not explicitly described.

It shall be understood that although the terms “first” and “second” etc. may be used herein to describe various elements, these elements should not be limited by these terms. These terms are only used to distinguish functionalities of various elements. As used herein, the term “and/or” includes any and all combinations of one or more of the listed terms.

The terminology used herein is for the purpose of describing particular embodiments only and is not intended to be limiting of example embodiments. As used herein, the singular forms “a”, “an” and “the” are intended to include the plural forms as well, unless the context clearly indicates otherwise. It will be further understood that the terms “comprises”, “comprising”, “has”, “having”, “includes” and/or “including”, when used herein, specify the presence of stated features, elements, and/or components etc., but do not preclude the presence or addition of one or more other features, elements, components and/or combinations thereof.

As used in this application, the term “circuitry” may refer to one or more or all of the following:
(a) hardware-only circuit implementations (such as implementations in only analog and/or digital circuitry) and
(b) combinations of hardware circuits and software, such as (as applicable):
   (i) a combination of analog and/or digital hardware circuit(s) with software/firmware and
   (ii) any portions of hardware processor(s) with software (including digital signal processor(s)), software, and memory(ies) that work together to cause an apparatus, such as a mobile phone or server, to perform various functions) and
(c) hardware circuit(s) and or processor(s), such as a microprocessor(s) or a portion of a microprocessor(s), that requires software (e.g., firmware) for operation, but the software may not be present when it is not needed for operation.

This definition of circuitry applies to all uses of this term in this application, including in any claims. As a further example, as used in this application, the term circuitry also covers an implementation of merely a hardware circuit or processor (or multiple processors) or portion of a hardware circuit or processor and its (or their) accompanying software and/or firmware. The term circuitry also covers, for example and if applicable to the particular claim element, a baseband integrated circuit or processor integrated circuit for a mobile device or a similar integrated circuit in server, a cellular network device, or other computing or network device.

As used herein, the term “communication network” refers to a network following any suitable communication standards, such as fifth generation (5G) systems, Long Term Evolution (LTE), LTE-Advanced (LTE-A), Wideband Code Division Multiple Access (WCDMA), High-Speed Packet Access (HSPA), Narrow Band Internet of Things (NB-IoT) and so on. Furthermore, the communications between a terminal device and a network device in the communication network may be performed according to any suitable generation communication protocols, including, but not limited to, the first generation (1G), the second generation (2G), 2.5G, 2.75G, the third generation (3G), the fourth generation (4G), 4.5G, the future fifth generation (5G) new radio (NR) communication protocols, and/or any other protocols either currently known or to be developed in the future. Embodiments of the present disclosure may be applied in various communication systems. Given the rapid development in communications, there will of course also be future type communication technologies and systems with which the present disclosure may be embodied. It should not be seen as limiting the scope of the present disclosure to only the aforementioned system.

As used herein, the term “network device” refers to a node in a communication network via which a terminal device accesses the network and receives services therefrom. The network device may refer to a base station (BS) or an access point (AP), for example, a node B (NodeB or NB), an evolved NodeB (eNodeB or eNB), a NR Next Generation NodeB (gNB), a Remote Radio Unit (RRU), a radio header (RH), a remote radio head (RRH), Integrated Access and Backhaul (IAB) node, a relay, a low power node such as a femto, a pico, and so forth, depending on the applied terminology and technology. The network device is allowed to be defined as part of a gNB such as for example in CU/DU split in which case the network device is defined to be either a gNB-CU or a gNB-DU.

The term “terminal device” refers to any end device that may be capable of wireless communication. By way of example rather than limitation, a terminal device may also be referred to as a communication device, user equipment (UE), a Subscriber Station (SS), a Portable Subscriber Station, a Mobile Station (MS), or an Access Terminal (AT). The terminal device may include, but not limited to, a mobile phone, a cellular phone, a smart phone, voice over IP (VOIP) phones, wireless local loop phones, a tablet, a wearable terminal device, a personal digital assistant (PDA), portable computers, desktop computer, image capture terminal devices such as digital cameras, gaming terminal devices, music storage and playback appliances, vehicle-mounted wireless terminal devices, wireless endpoints, mobile stations, laptop-embedded equipment (LEE), laptop-mounted equipment (LME), USB dongles, smart devices, wireless customer-premises equipment (CPE), an Internet of Things (IoT) device, a watch or other wearable, a head-mounted display (HMD), a vehicle, a drone, a medical device and applications (e.g., remote surgery), an industrial device and applications (e.g., a robot and/or other wireless devices operating in an industrial and/or an automated processing chain contexts), a consumer electronics device, a device operating on commercial and/or industrial wireless networks, and the like. The terminal device may also correspond to Mobile Termination (MT) part of the integrated access and backhaul (IAB) node (a.k.a. a relay node). In the following description, the terms “terminal device”, “communication device”, “terminal”, “user equipment” and “UE” may be used interchangeably.

Although functionalities described herein can be performed, in various example embodiments, in a fixed and/or a wireless network node, in other example embodiments, functionalities may be implemented in a user equipment apparatus (such as a cell phone or tablet computer or laptop computer or desktop computer or mobile IoT device or fixed IoT device). This user equipment apparatus can, for example, be furnished with corresponding capabilities as described in connection with the fixed and/or the wireless network node(s), as appropriate. The user equipment apparatus may be the user equipment and/or or a control device, such as a chipset or processor, configured to control the user equipment when installed therein. Examples of such functionalities include the bootstrapping server function and/or the home subscriber server, which may be implemented in the user equipment apparatus by providing the user equipment apparatus with software configured to cause the user equipment apparatus to perform from the point of view of these functions/nodes.

When multiple unicast and multicast services are received, the terminal device may generate sub-codebooks for each of the services respectively, and concatenate the sub-codebooks in the same HARQ codebook. The terminal device may then transmit the HARQ codebook to its serving network device on PUCCH.

In general, two types of HARQ codebook are used by UEs in RRC_CONNECTED state for reporting the reception of unicast and multicast services, namely, type-1 (semi-static) HARQ and type-2 (dynamic) HARQ codebooks. Type-1 HARQ codebook includes a fixed size of HARQ bits for all the possible PDSCH occasions. The type-2 HARQ codebook is constructed based on downlink assignment index (DAI) values in respective DCIs for unicast and multicast services. Thus, the number of HARQ bits for Type-2 HARQ codebook depends on a largest DAI value for unicast service and a largest DAI value for each of multicast services.

However, in some cases, a HARQ-ACK codebook transmitted from the UE may not match the size of the HARQ-ACK codebook expected by the gNB, and thus the HARQ-ACK feedback in the HARQ-ACK codebook cannot be decoded successfully, i.e., HARQ-ACK codebook size ambiguity between the UE and the gNB. This may be due to a misunderstanding of the HARQ-ACK codebook size between the UE and the gNB.

For example, in a case where type-1 HARQ-ACK codebook is configured for reporting the reception of unicast/multicast services, the gNB may transmit a unicast transmission scheduled by first DCI and a multicast transmission scheduled by second DCI in an FDM-ed manner. If the second DCI for the multicast transmission is unsuccessfully decoded by the UE, the UE would not be aware of the multicast transmission. In this case, the UE generates a HARQ-ACK codebook including only the HARQ feedback for the unicast transmission, i.e., the unicast sub-codebook. However, the gNB may expect to receive a HARQ-ACK codebook including a unicast sub-codebook and a multicast sub-codebook, if they were to be multiplexed and sent using the same PUCCH resource when the multicast DCI would be successfully decoded. Thus, the size of the HARQ-ACK codebook transmitted by the UE does not match the size expected by the gNB. Moreover, the gNB is unable to distinguish which of the services does the HARQ-ACK codebook belong to, and thus it cannot interpret the received codebook correctly, and both the HARQ feedbacks for the unicast and multicast services are lost.

In a case where type-2 HARQ-ACK codebook is configured for reporting the reception of unicast/multicast services and the gNB transmits the unicast service and the multicast service to the UE, similar problems may arise. For example, if the DCI(s) for multicast TBs cannot be decoded successfully, the UE generates only the unicast sub-codebook with a smaller size as compared with the size expected by the gNB, if unicast and multicast sub-codebooks were to be multiplexed and sent using the same PUCCH resource when the multicast DCI(s) would be successfully decoded. As a result, the gNB can neither interpret the received codebook correctly, nor distinguish which of the services does the HARQ-ACK codebook belong to, and thus both the HARQ feedbacks for the unicast and multicast services are lost.

For the cases where the gNB provides multiple multicast services without the unicast service, the gNB and the UE may face a similar problem on the size ambiguity. For example, the gNB may schedule two TBs for each of the two multicast services, and the last DCI that schedules the multicast TB with a largest DAI value may be lost or may not successfully be decoded by the UE, and thus the UE may generate a codebook of size 3, if multicast sub-codebooks were to be multiplexed and sent using the same PUCCH resource and type-2 HARQ-ACK codebook would be in use. In this case, the gNB would not distinguish which of the TBs is lost from the received codebook, resulting in loss of the feedbacks.

For a more complex case where the gNB transmits a unicast service and multiple multicast services to the UE, if the DCI(s) for one of the multicast services is not successfully decoded, the UE would not be able to produce a sub-codebook for the corresponding multicast service, again, if unicast and multicast sub-codebooks were to be multiplexed and sent using the same PUCCH resource when the multicast DCI(s) would be successfully decoded and type-2 HARQ-ACK codebook would be in use. As a result, the gNB receives a codebook with a size smaller than expected. Due to the size mismatch, the gNB cannot interpret the codebook correctly. Moreover, the gNB cannot distinguish which of services does the received sub-codebook belong to.

The ambiguity of the HARQ-ACK codebook size would in turn lead to a series of problems in the communication system, such as, a loss of HARQ-ACK feedback, a retransmission problem, a decrease of spectral efficiency, and an increase of packet loss rate.

In order to solve the above and other potential problems, embodiments of the present disclosure provide an enhanced HARQ feedback reporting mechanism. With the mechanism, the ambiguity of the HARQ-ACK codebook size can be eliminated, and the UE and the gNB have the same understanding on the content of the HARQ-ACK codebook. Further, the gNB is capable of distinguishing which of the services does the received sub-codebooks belong to, even in case that the DCI is missed or not successfully decoded by the UE. By applying the enhanced mechanism, the gNB can accurately schedule retransmissions of unicast and multicast services in time, and unnecessary retransmissions can be avoided. As such, the spectral efficiency and packet loss rate of the communication system can be improved.

Example embodiments of the present disclosure will be described in detail below with reference to the accompanying drawings. Principle and embodiments of the present disclosure will be described in detail below with reference to the accompanying drawings.

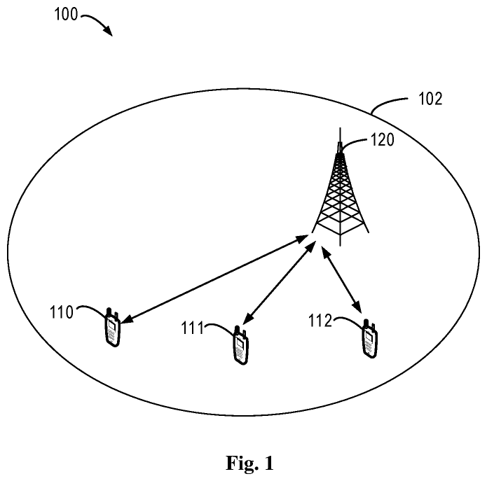

FIG. 1 illustrates an example network system 100 in which example embodiments of the present disclosure can be implemented. As shown in FIG. 1, the network system 100 includes a group of first devices 110 to 112 and a second device 120 that provides a radio coverage in a cell 102.

The group of first devices 110 to 112, which may also be referred to as terminal devices 110 to 112 hereinafter, are located within the cell 102 an served by the second device 120. The first devices 110 to 112 may communicate with the second device 120 via a wireless communication channel. In particular, the first devices 110 to 112 may transmit uplink (UL) transmission to the second device 120 on a UL channel, and the second device 120 may transmit (DL) transmission to the first devices 110 to 112 on a DL channel.

The second device 120, which may also be referred to as a network device 120 hereinafter, may provide unicast and MBS services to the first device 110 to 112. As discussed above, the MBS services may be provided via the PTM transmission. In some example embodiments, the first devices 110 to 112 each may transmit an indication message to the second device 120 for indicating an interest of a group of services that includes at least one MBS service. In the following description, the first device 110 may be referred to as a representative of the first devices 110 to 112, but the implementations of the present disclosure are applicable to all the terminal devices in the cell 102.

Prior to transmitting TBs on the DL data channel (e.g., PDSCH), the second device 120 may transmit DCI including configuration parameters for scheduling respective TBs via a DL control channel (e.g., a physical downlink control channel (PDCCH)). In a case where multiple services are provided to the first device 110, the second device 120 may transmit different DCIs to schedule TBs of respective services. For example, the second device 120 may transmit first DCI for scheduling the unicast TB and at least one different second DCI for scheduling at least one multicast TB.

By detecting and successfully decoding the DCI, the first device 110 then receives corresponding TBs on PDSCH. The first device 110 may report HARQ feedback for the TBs on PUCCH. For example, the second device 120 may configure a set of K1 values (e.g., the set {1, 2, 3}) indicating offsets between the PDSCH resource and the corresponding PUCCH resource in time domain, and a time domain resource allocation (TDRA) table to the first device 110. The first device 110 may construct a HARQ-ACK codebook including HARQ feedbacks for corresponding TBs based on a set of K1 values and the TDRA table, and each HARQ feedback is represented by a 1-bit ACK/NACK value.

In some example embodiments, the first device 110 may generate a separate sub-codebook for each of different unicast and MBS services. The sub-codebooks are concatenated in the HARQ-ACK codebook in a certain order, in case they are to be multiplexed. For example, the unicast sub-codebook may precede the multicast sub-codebooks. Additionally, or alternatively, the sub-codebooks may be concatenated based on the order of radio network temporary identities associated with unicast and multicast services. To identify which service does each of the sub-codebooks (or the HARQ-ACK codebook per se in some cases) belong to, identification information about unicast and MBS services is introduced to the HARQ reporting mechanism between the first device 110 and the second device 120, which will be discussed in details below.

It is to be understood that the number of terminal devices and network device shown in FIG. 1 is given for the purpose of illustration without suggesting any limitations. The network system 100 may include any suitable number of terminal devices, network device and additional devices adapted for implementations of the present disclosure.

Only for ease of discussion, the first devices 110 to 112 are illustrated as UEs, and the second device 120 is illustrated as a base station. It is to be understood that UE and base station are only example implementations of the first devices 110 to 112 and the second device 120 respectively, without suggesting any limitation as to the scope of the present application. Any other suitable implementations are possible as well.

Depending on the communication technologies, the network 100 may be a Code Division Multiple Access (CDMA) network, a Time Division Multiple Address (TDMA) network, a Frequency Division Multiple Access (FDMA) network, an Orthogonal Frequency-Division Multiple Access (OFDMA) network, a Single Carrier-Frequency Division Multiple Access (SC-FDMA) network or any others. Communications discussed in the network 100 may conform to any suitable standards including, but not limited to, New Radio Access (NR), Long Term Evolution (LTE), LTE-Evolution, LTE-Advanced (LTE-A), Wideband Code Division Multiple Access (WCDMA), Code Division Multiple Access (CDMA), cdma2000, and Global System for Mobile Communications (GSM) and the like. Furthermore, the communications may be performed according to any generation communication protocols either currently known or to be developed in the future. Examples of the communication protocols include, but not limited to, the first generation (1G), the second generation (2G), 2.5G, 2.75G, the third generation (3G), the fourth generation (4G), 4.5G, the fifth generation (5G) communication protocols. The techniques described herein may be used for the wireless networks and radio technologies mentioned above as well as other wireless networks and radio technologies. For clarity, certain aspects of the techniques are described below for LTE, and LTE terminology is used in much of the description below.

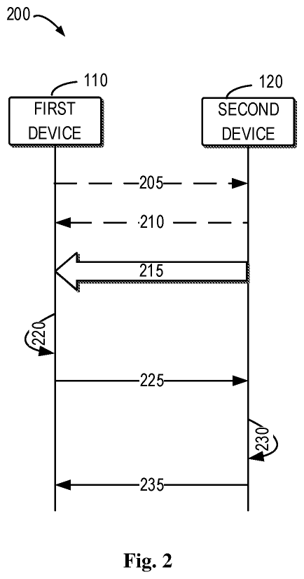

Principle and implementations of the present disclosure will be described in detail below with reference to FIGS. 2 to 7. FIG. 2 shows a signaling chart illustrating a process of measurement reporting mechanism according to some example embodiments of the present disclosure. For the purpose of discussion, the process 200 will be described with reference to FIG. 1. The process 200 may involve the first device 110 and the second device 120 as shown in FIG. 1.

As described above, the second device 120 may be able to provide a plurality of unicast and MBS services. In the process 200, the first device may transmit 205 an indication message (which is also referred to as a second message hereinafter) indicative of an interest of a group of the services. The group of the services may include: i) one or more unicast services; ii) one or more MBS services; and iii) a combination of the unicast and MBS services.

The second device 120 may transmit 210 a first message indicative of identification information for the group of services. In some example embodiments, the first message may include a RRC message or any other message suitable for carry such identification information. The present disclosure is not limited in this respect.

The indication message is used for determining the identification information, such as, how many bits are needed to identify the sub-codebooks for the group of services. By way of example, in addition to a unicast service, the first device 110 transmits the indication message for indicating an interest of two different MBS services, then the multiplexed HARQ-ACK codebook transmitted by the first device 110 may include one of the 6 possible combinations of sub-codebooks, i.e., the HARQ-ACK codebook includes the sub-codebook for only one of the three services, the multiplexed HARQ-ACK codebook includes the sub-codebooks for two of the three services, or the multiplexed HARQ-ACK codebook includes the sub-codebooks for all the three services. Those possible combinations can be represented by a 3-bit index, which may be added to the concatenation of sub-codebooks for indicating the structure of the HARQ-ACK codebook transmitted by the first device. In this embodiment, the identification information or the length of the indexes can depend on how many services the first device 110 expects to receive, and thus less overhead can be introduced to uplink control information (UCI).

However, the first message is not mandatory for the process 200, and in some cases the process 200 can be implemented without signalling for configuring the identification information. In some example embodiments, the identification information may be preconfigured at the first device 110 and the second device 120.

For example, a part of or complete group RNTIs (G-RNTIs) associated with the MBS services and a part of or complete C-RNTIs associated with the unicast services or preconfigured identifiers for the unicast services may be used as the identification information. The preconfigured identifiers for the unicast services may be hard-coded and may be a special character.

In the context of the present disclosure, the term “preconfigured” means the identifiers or special characters for unicast services are specified at the first device 110 and the second device 120 and in this case no signalling is needed. The term “preconfigured” may also refer to a case where the identifiers or special characters for unicast services are configured to the first device 110 by the second device in advance (e.g., before the process 200) and in this case, signalling for configuring the identifiers or special characters is transmitted before the performance of the process 200. In the latter case, the identifiers or special characters is non hard-coded.

In some example embodiments, the identification information may include indexes of the group of services. The indexes may be represented by binary numbers each corresponding to one of RNTIs associated with the group of services. This may need a smaller number of bits as compared with identifying services by using partial or entire RNTIs. Table 1 shows an example mapping relation of indexes and the group of services including a unicast service 1 and two multicast services, i.e., MBS 1 and MBS 2.

TABLE 1
Example indexing of unicast and MBS services

| Service | RNTI | Index (binary) |
|---|---|---|
| Unicast service 1 | 16-bit C-RNTI | 0 (00) |
| MBS 1 | 16-bit G-RNTI 1 | 1 (01) |
| MBS 2 | 16-bit G-RNTI 2 | 2 (10) |

The mapping relation may be transmitted in the first message.

The second device 120 transmits 215 the group of services to the first device 110. The group of services may include various combinations of services, for example, (i) only unicast service(s), (ii) only multicast service(s), or (iii) both of the unicast service(s) and the multicast service(s).

The first device 110 may detect respective DCI(s) for the group of services. If the first device 110 successfully detects the DCI(s), the first device 110 may then receive TBs of the service scheduled by the DCI(s). Otherwise, if the DCI(s) is lost or unsuccessfully decoded, the first device 110 may not receive the TBs, which may in turn impact generation of the HARQ-ACK codebook.

Upon receipt of at least one of the group of services from the second device 120, the first device 110 generates 220 the HARQ-ACK codebook comprising HARQ feedback and identification information for the at least one service received by the first device 110. The HARQ-ACK codebook may be type-1 or type-2 HARQ-ACK codebook.

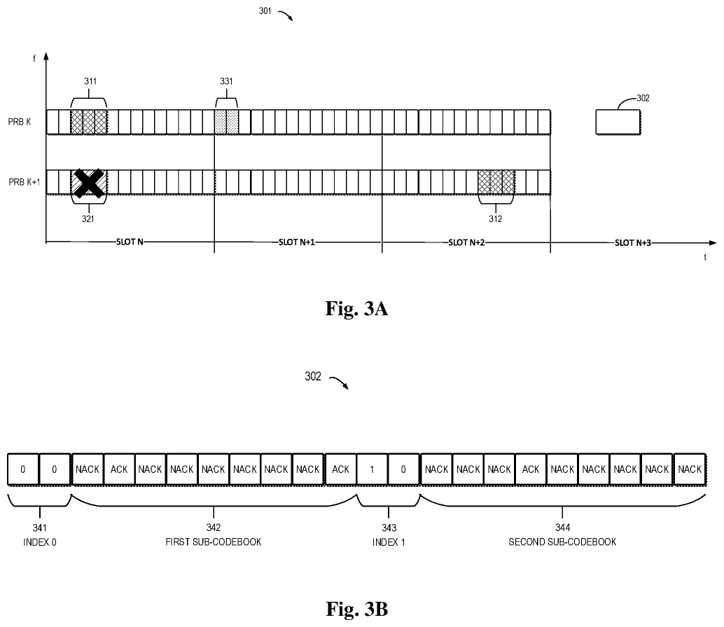

Depending on which one or more of the group of services are received by the first device 110, the HARQ-ACK codebook may be different. FIG. 3A illustrates a schematic diagram of an example data transmissions 300 between the terminal device and the network device according to some example embodiments of the present disclosure. The terminal device may be the first device 110 and the network device may be the second device 120 as shown in FIG. 1. For the purpose of discussion, the data transmissions 300 will be described with reference to FIG. 1.

As shown in FIG. 3A, the second device 120 provides a unicast service and two different MBS services in an FDM-ed manner, and type-1 HARQ codebook is configured for the data transmission 301. According to the resource allocation for the unicast and MBS services, the unicast service includes the unicast TB 311 at slot N and the unicast TB 312 at slot N+2, and the two different MBS services include the MBS TB 321 at slot N and the MBS TB 331 at slot N+1, where only one TB is assumed to be transmitted per slot for the same service, i.e., less than 5 MIMO-layers are used in the transmission. The example TDRA table configured for the first device 110 is shown in Table. 2, assuming that k0=1 and the mapping type is type A. In addition, it is assumed that the K1 values configured by the second device 120 are the set {1, 2, 3} as the set dl-dataToUl-Ack.

TABLE 2
TDRA table

| Entry | First symbol | Last symbol |
|---|---|---|
| 1 | 1 | 2 |
| 2 | 3 | 5 |
| 3 | 8 | 11 |

The HARQ feedback for the received TBs is scheduled at slot N+3, and the mapping relation is as shown in Table 1. The DCI for the MBS TB 321 is unsuccessfully decoded by the first device 110, thus the first device 110 generates the HARQ-ACK codebook comprising a first sub-codebook for the unicast TBs 311 and 312 and a second sub-codebook for the MBS TB 331. To identify which service does each of the sub-codebooks belong to, identification information is added to the HARQ-ACK codebook.

FIG. 3B illustrates a schematic diagram of an example HARQ-ACK codebook 302 for the data transmission 301 as shown in FIG. 3A according to some example embodiments of the present disclosure. Herein, it is assumed that the UE successfully decodes the TBs, whose DCIs are successfully decoded. As shown in FIG. 3B, the HARQ-ACK codebook 302 includes a first index field 341 for index 0 of the first sub-codebook 342, the first sub-codebook 342 for the unicast TBs 311 and 312, a second index field 343 for index 1 of the second sub-codebook 343, and the second sub-codebook 343 for the MBS TB 331. The indexes serve as the identification information, and each of the indexes precedes the corresponding sub-codebooks. As such, despite the lack of a sub-codebook for the MBS TB 321, the second device 120 is capable of determining which of the services are failed to be received and distinguish which service each of the received sub-codebooks belongs to.

In embodiments where type-2 HARQ codebook is configured for the HARQ feedback between the first device 110 and the second device 120, the identification information may further indicate a size of each of the sub-codebooks transmitted by the first device 110. To indicate a size of each of the sub-codebooks, the identification information may further include length information for the respective sub-codebooks. For example, the length information may be represented by a predetermined number of bits (e.g., 4 bits) and precede to a corresponding sub-codebook.

With the length information, when the second device 120 receives a sub-codebook with a smaller size than the expected size, the second device 120 may determine that at least the last DCI with a largest DAI value for the corresponding service is missing or failed to be decoded. The second device 120 may then schedule retransmission of the corresponding TB.

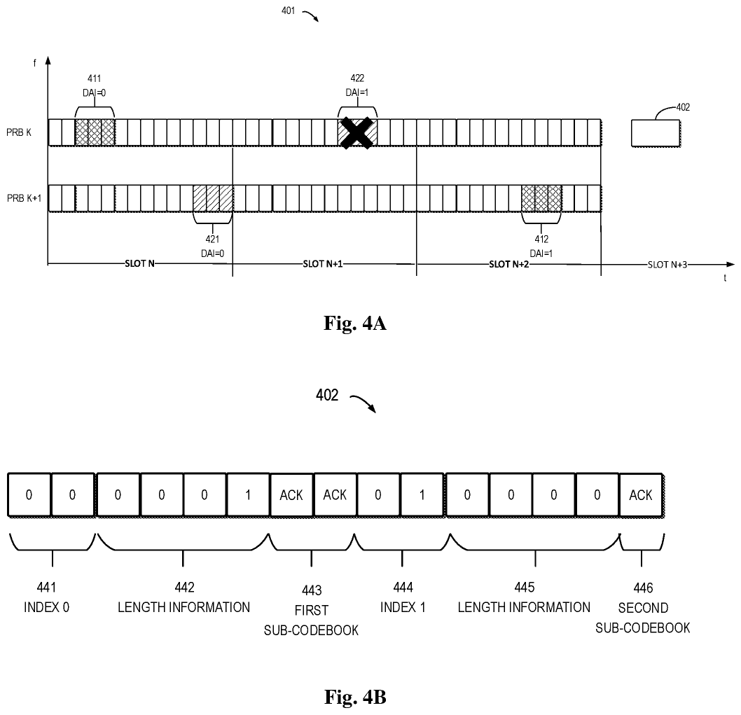

FIG. 4A illustrates a schematic diagram of an example data transmission 401 between the terminal device and the network device according to some example embodiments of the present disclosure. The terminal device may be the first device 110 and the network device may be the second device 120 as shown in FIG. 1. For the purpose of discussion, the data transmissions 300 will be described with reference to FIG. 1.

As shown in FIG. 4A, the second device 120 provides a unicast service and an MBS service, and type-2 HARQ codebook is configured for the data transmission 401. Again, only one TB is assumed to be transmitted per slot for the same service. According to the resource allocation for the unicast and MBS services, the unicast service includes the unicast TB 411 at slot N and the unicast TB 412 at slot N+2 and the MBS service includes the MBS TB 421 at slot N and the MBS TB 422 at slot N+1. The HARQ feedback 402 for the received TBs is scheduled at slot N+3, and the mapping relation is as shown in Table 1. The DCI for scheduling the MBS TB 422 is unsuccessfully decoded by first device, that is, the DAI=1 is missed, and in this case, the first device 110 regards the MBS TB 421 as the only TB for the MBS service. Hence, the first device 110 generates the HARQ-ACK codebook comprising the first sub-codebook for the unicast TBs 411 and 412 and the second sub-codebook for the MBS TB 421. To identify a size of each of the sub-codebooks and which service does it belong to, the identification information is added to the HARQ-ACK codebook.

FIG. 4B illustrates a schematic diagram of an example HARQ-ACK codebook 402 for the data transmission 401 as shown in FIG. 4A according to some example embodiments of the present disclosure. Herein, it is assumed that the UE successfully decodes the TBs, whose DCIs are successfully decoded. As shown in FIG. 4B, the HARQ-ACK codebook 402 includes a first index field 441 for index 0 of the first sub-codebook 443 for the unicast TBs 411 and 412, length information 442 for the first sub-codebook 443, the first sub-codebook 443 comprising HARQ bits for the unicast TBs 411 and 412, a second index filed 444 for index 1 of the second sub-codebook 446 for multicast TB 421, length information 445 for the second sub-codebook 446, and the second sub-codebook 446 comprising a HARQ bit for the MBS TB 421.

Since the length information 442, i.e., “0001” indicates a size “2” of the first sub-codebook 443 equal to the expected size of the first sub-codebook 443, the second device 120 may determine that all the unicast TBs 411 and 412 are received by the first device 110. Moreover, the length information 445, i.e., “0000” indicates that a size “1” of the second sub-codebook 446 is smaller than the expected size of the second sub-codebook 446, the second device 120 may determine that the last DCI for scheduling the MBS TBs 422 is lost or failed to be decoded. As such, the size ambiguity of sub-codebooks in the HARQ-ACK codebook is eliminated, and the second device 120 can schedule necessary retransmission of the MBS service. It should be understood that all the configurations and values about the indexes are given as one of various implementations of the present disclosure without limitation, any other configurations and values of indexes suitable for implementing the example embodiments are also possible.

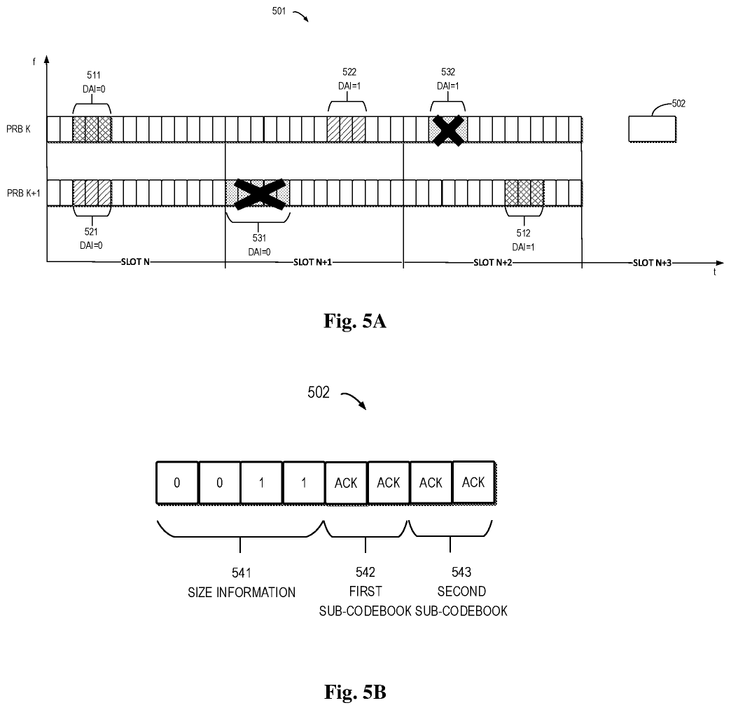

The enhanced mechanism can be implemented even for the case where all the DCI(s) for a service cannot be decoded by the first device 110. In some example embodiments, the identification information may include size information indicating a total size of the sub-codebooks in the HARQ-ACK codebook. FIG. 5A illustrates a schematic diagram of an example data transmission 501 between the terminal device and the network device according to some example embodiments of the present disclosure. The terminal device may be the first device 110 and the network device may be the second device 120 as shown in FIG. 1. For the purpose of discussion, the data transmissions 300 will be described with reference to FIG. 1.

As shown in FIG. 5A, the second device 120 provides a unicast service and two MBS services, and type-2 HARQ codebook is configured for the data transmission 501. According to the resource allocation for the unicast and MBS services, the unicast service includes the unicast TB 511 at slot N and the unicast TB 512 at slot N+2, the MBS service 1 includes the MBS TB 521 at slot N and the MBS TB 522 at slot N+1, and the MBS service 2 includes the MBS TB 531 at slot N+1, and MBS TB 532 at slot N+2. The HARQ feedback 502 for the received TBs is scheduled at slot N+3, and the mapping relation is as shown in Table 1. The DCIs for scheduling the MBS TBs 531 and 532 are unsuccessfully decoded, that is, both DAI=0 and DAI=1 are missed. In this case, the first device 110 is unaware of the MBS service 2. Hence, the first device 110 generates the HARQ-ACK codebook comprising the first sub-codebook for the unicast TBs 511 and 512 and the second sub-codebook for the MBS TBs 521 and 522.

The first device 110 may then determine the total size of the first sub-codebook and the second sub-codebook, and add the size information in the HARQ-ACK codebook. FIG. 5B illustrates a schematic diagram of an example HARQ codebook 502 for the data transmission 501 as shown in FIG. 5A according to some example embodiments of the present disclosure. As an example configuration of the size information, “0000” indicates the total size “1”, “0001” indicates the total size “2”, “0010” indicates the total size “3”, “0011” indicates the total size “4” and so on. As shown in FIG. 5B, the HARQ-ACK codebook 502 includes size information 541 of the HARQ-ACK codebook, the first sub-codebook 542 comprising 2 HARQ bits for the unicast TBs 511 and 512, and the second sub-codebook 543 comprising 2 HARQ bits for the MBS TBs 521 and 522. Thus, the size information 541 is set to “0011” to indicate a total size “4”. It should be understood that the configuration of size information and the structure of the HARQ-ACK codebook 502 shown in FIG. 5B are given as one of the various implementations of the example embodiments, any other configuration and structure are also possible. The present disclosure is not limited in this respect.

The first device 110 transmits 225 the HARQ-ACK codebook to the second device 120. Upon receipt of the HARQ-ACK codebook, the second device 120 may determine 230, based on the identification information, at least one of the group of services is unsuccessfully received at the first device 110. The second device 120 may then transmit, 235 to the first device, retransmission of the group of services.

For example, in the embodiments where the identification information comprises a first index of a combination of the at least one service, if the second device 120 determines that the first index is different from a second index of a combination of the group of services, the second device 120 may determine, based on the identification information, at least one of the group of services is unsuccessfully received at the first device 110.

In the embodiments where the identification comprises the total size of the sub-codebooks, the second device 120 may determine whether the total size of the sub-codebooks is equal to a total size expected by the second device 120 based on the size information. If the total size of the sub-codebooks is smaller than the expected size, the second device 120 may determine that the first device 110 has missed at least one of the last DAIs for the group of services. The second device 120 may then retransmit all the TBs of the group of services to the first device 110.

According to the example embodiments of the present disclosure, an enhanced mechanism for reporting HARQ feedback is provided. With the mechanism, the ambiguity of the structure and sizes of the sub-codebooks in the HARQ-ACK codebook can be eliminated. The TRP providing various services is capable of distinguishing which of the services the received sub-codebooks belong to, even in case that DCI for scheduling the services was missed or not successfully decoded by the UE. As such, the gNB can accurately schedule retransmissions of unicast and MBS services in time, and unnecessary retransmissions can be avoided. In this way, the spectral efficiency and packet loss rate of the communication system can be improved.

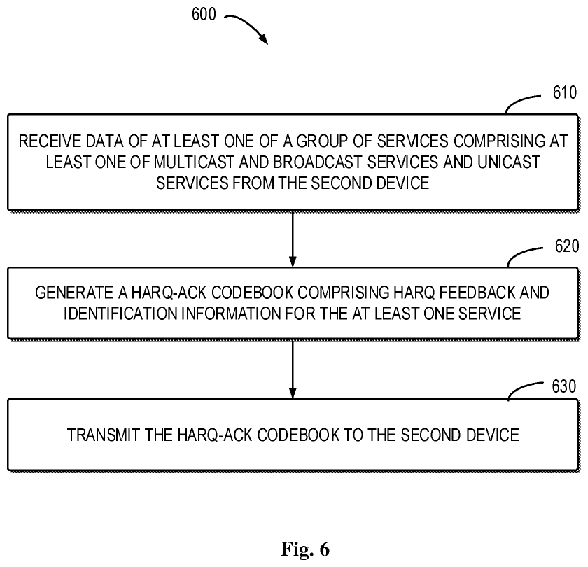

FIG. 6 illustrates a flowchart of an example method 600 for reporting HARQ feedback according to some example embodiments of the present disclosure. The method 600 can be implemented at a terminal device, e.g., the first device 110 described with reference to FIG. 1. For the purpose of discussion, the method 600 will be described with reference to FIG. 1.

At 610, the first device 110 receives data of at least one of a group of services comprising at least one of MBS services and unicast services from the second device 120.

In some example embodiments, the first device 110 may receive, from the second device 120, a first message indicative of identification information for the group of services. The first message may be a RRC message or any other message suitable for carry the identification information.

In some example embodiments, identification information for the group of services may be preconfigured at the first device 110 and the second device 120. For example, the identification information may include, but not limited to, preconfigured identifiers for the unicast services, part of or complete C-RNTIs associated with the unicast services, part of or complete G-RNTIs associated with the multicast services and so on.

In some example embodiments, the identification information may include indexes of the group of services.

In some example embodiments, the identification information may include a mapping relation of combinations of the group of services that the first device 110 is interested in and indexes associated with the combinations.

The indexes associated with the combinations may be determined based on a number of services in the group. In these embodiments, the first device 110 may transmit a second message indicative of an interest of the group of the services to the second device 120. Upon receipt of the second message, the second device 120 may determine how many combinations of the group of services can be formed. The second device 120 may then transmit the first message comprising the mapping relation to the first device 110.

At 620, the first device 110 generates a HARQ-ACK codebook comprising HARQ feedback and identification information for the at least one service.

In a case where the at least one service comprises a first service of the group services, that is, the first device 110 receives only one service from the second device 120, the HARQ-ACK codebook may include a HARQ feedback and identification information for the first service.

In another case where the at least one service comprises a plurality of the services, that is, the first device 110 receives more than one services from the second device 120, the HARQ-ACK codebook may include a plurality of sub-codebooks each comprising HARQ feedback and identification information for one of the plurality of the services.

In some example embodiments where the HARQ-ACK codebook is a Type-2 HARQ-ACK codebook, the identification information further comprises length information for each of the plurality of the sub-codebooks.

In some example embodiments, the length information may be determined by the first device 110 based on a largest DAI value associated with each of the plurality of the sub-codebooks.

At 630, the first device 110 transmits the HARQ-ACK codebook to the second device 120. In some example embodiments, the first device 110 may receive, from the second device 120, retransmission of the previously unsuccessfully received data of at least one of the group of services that the first device 110 is interested in.

According to the example embodiment, an enhanced HARQ feedback reporting mechanism is provided for eliminating the ambiguity of the HARQ-ACK codebook size. Thus, the gNB is capable of distinguishing which of the services the received sub-codebooks belong to, even in case that the DCI was missed or not successfully decoded by the UE. As a result, retransmissions of unicast and multicast services can be accurately scheduled in time, and unnecessary retransmissions can be avoided.

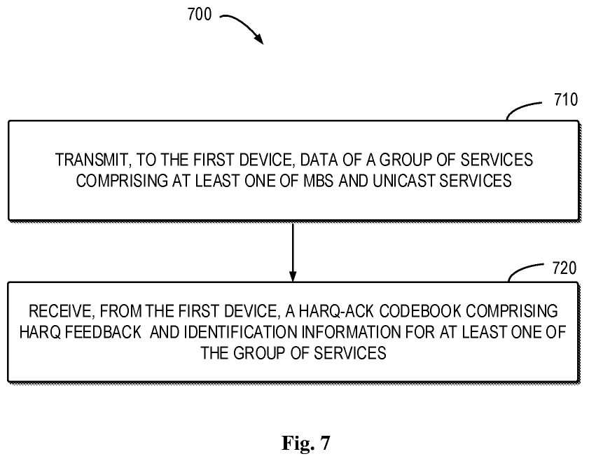

FIG. 7 illustrates a flowchart of an example method 700 for reporting HARQ feedback according to some example embodiments of the present disclosure. The method 700 can be implemented at a base station or a TRP, e.g., the second device 120 described with reference to FIG. 1. For the purpose of discussion, the method 700 will be described with reference to FIG. 1.

At 710, the second device 120 transmits, to the first device 110, data of a group of services comprising at least one of MBS services and unicast services.

In some example embodiments, prior to transmitting the group of services, the second device 120 may transmit, to the first device 110, a first message indicative of identification information about the group of services.

In some other example embodiments, the identification information about the group of services may be preconfigured at the first device 110 and the second device 120. In other words, no signaling for configuring the identification information is needed for these embodiments.

In some example embodiments, the identification information may include, but not limited to, preconfigured identifiers for the unicast services, part of or complete C-RNTIs associated with the unicast services, or part of or complete G-RNTIs associated with the multicast services.

In some example embodiments, the identification information comprises at least one index of the at least one service. The second device 120 may transmit indexes of the group of services in the first message.

In some example embodiments, the identification information may include a mapping relation of combinations of the group of services and indexes associated with the combinations.

The indexes associated with the combinations may be determined based on a number of services in the group. In these embodiments, the second device 120 may receive, from the first device 110, a second message indicative of an interest of the group of the services. The second device 120 may determine the combinations of the group of services and the indexes associated with the combinations. The second device 120 may then transmit, to the first device 110, a first message comprising the mapping relation of the combinations and the indexes.

At 720, the second device 120 receives, from the first device 110, a HARQ-ACK codebook comprising HARQ feedback and identification information for at least one of the group of services.

In some example embodiments, the second device 120 may determine, based on the identification information, that data of at least one of the group of services is unsuccessfully received at the first device 110. In these embodiments, the second device 120 may then transmit, to the first device 110, retransmission of the previously unsuccessfully received data of the at least one of the group of services.

In some embodiments where the second device 120 determines that the first index of the combination is different from a second index of a combination of the group of services, the second device 120 may determine, based on the identification information, at least one of the group of services is unsuccessfully received at the first device 110. In this case, the second device 120 may transmit, to the first device 110, retransmission of the at least one unsuccessfully received service.

In some example embodiments, the at least one service may include a first service of the group services, and the HARQ-ACK codebook may include a HARQ feedback and identification information for the first service.

In some example embodiments, the at least one service may include a plurality of the services in the group, and the HARQ-ACK codebook may include a plurality of sub-codebooks each comprising HARQ feedback and identification information about one of the plurality of the services.

In some example embodiments where the HARQ-ACK codebook is a Type-2 HARQ-ACK codebook, the identification information may further comprise length information indicating a size of each of the plurality of the sub-codebooks. For example, the length information may be determined based on a largest DAI value associated with each of the plurality of the sub-codebooks.

In the above embodiments, the second device 120 may determine that a size of at least one of the plurality of the sub-codebooks is different from a size expected by the second device 120. The second device 120 may determine, based on the identification information, the at least one of the group of services is unsuccessfully received at the first device 110. The second device 120 may then transmit, to the first device 110, retransmission of the at least one unsuccessfully received service.

According to the example embodiment, an enhanced HARQ feedback reporting mechanism is provided for eliminating the ambiguity of the HARQ-ACK codebook size. The enhanced mechanism is capable of identifying sub-codebooks for different unicast and MBS services with minimum number of additional bits. In this way, the UE and the gNB have the same understanding on the content of the HARQ-ACK codebook. By applying the enhanced mechanism, the gNB can accurately schedule retransmissions of unicast and multicast services in time, and unnecessary retransmissions can be avoided. As such, the spectral efficiency and packet loss rate of the communication system can be improved.

In some example embodiments, a first apparatus capable of performing the method 600 (for example, the first device 110) may comprise means for performing the respective steps of the method 600. The means may be implemented in any suitable form. For example, the means may be implemented in a circuitry or software module. The first apparatus may be implemented as or included in the first device 110. In some embodiments, the means may comprise at least one processor and at least one memory including computer program code. The at least one memory and computer program code are configured to, with the at least one processor, cause performance of the first apparatus.

In some example embodiments, the first apparatus comprises: means for upon receipt of data of at least one of a group of services from a second device, generating a Hybrid Automatic Repeat Request acknowledgement (HARQ-ACK) codebook comprising HARQ feedback and identification information for the at least one service, the group of services comprising at least one of multicast and broadcast services (MBSs) and unicast services; and means for transmitting the HARQ-ACK codebook to the second device.

In some example embodiments, the first apparatus further comprises means for receiving, from the second device, a first message indicative of identification information for the group of services.

In some example embodiments, identification information for the group of services is preconfigured at the first apparatus and the second device.

In some example embodiments, the identification information comprises at least one of the following: preconfigured identifiers for the unicast services, part of or complete cell radio network temporary identity (C-RNTIs) associated with the unicast services, or part of or complete group RNTIs (G-RNTI) associated with the MBS services.

In some example embodiments, the identification information comprises indexes of the group of services.

In some example embodiments, the identification information comprises a mapping relation of combinations of the group of services and indexes associated with the combinations.

In some example embodiments, the first apparatus further comprises: means for receiving, from the second device, a first message comprising the mapping relation.

In some example embodiments, the at least one service comprises a first service of the group services, and the HARQ-ACK codebook comprises a HARQ feedback and identification information for the first service.

In some example embodiments, the at least one service comprises a plurality of the services in the group, and the HARQ-ACK codebook comprises a plurality of sub-codebook each comprising HARQ feedback and identification information for one of the plurality of the services.

In some example embodiments, the HARQ-ACK codebook is a Type-2 HARQ-ACK codebook, and the identification information further comprises length information for each of the plurality of the sub-codebooks.

In some example embodiments, the length information is determined by the first apparatus based on a largest downlink assignment index (DAI) value associated with each of the plurality of the sub-codebooks.

In some example embodiments, the first apparatus further comprises means for receiving, from the second device, retransmission of the previously unsuccessfully received data of at least one of the group of services.

In some example embodiments, the first apparatus is a terminal device, and the second device is a network device.

In some example embodiments, a second apparatus capable of performing the method 700 (for example, the second device 120) may comprise means for performing the respective steps of the method 700. The means may be implemented in any suitable form. For example, the means may be implemented in a circuitry or software module. The second apparatus may be implemented as or included in the second device 120. In some embodiments, the means may comprise at least one processor and at least one memory including computer program code. The at least one memory and computer program code are configured to, with the at least one processor, cause performance of the second apparatus.

In some example embodiments, the second apparatus comprises: means for transmitting, to a first device, data of a group of services comprising at least one of multicast and broadcast services (MBSs) and unicast services; and means for receiving, from the first device, a Hybrid Automatic Repeat Request acknowledgement (HARQ-ACK) codebook comprising HARQ feedback and identification information for at least one of the group of services.

In some example embodiments, the second apparatus further comprises: means for transmitting, to the first device, a first message indicative of identification information about the group of services.

In some example embodiments, the second apparatus further comprises: means for determining, based on the identification information, that data of at least one of the group of services is unsuccessfully received at the first device; and means for transmitting, to the first device, retransmission of the previously unsuccessfully received data of the at least one of the group of services.

In some example embodiments, identification information about the group of services is preconfigured at the first device and the second apparatus.

In some example embodiments, the identification information may include, but not limited to, preconfigured identifiers for the unicast services, partial or complete C-RNTIs associated with the unicast services, or partial or complete G-RNTIs associated with the multicast services.

In some example embodiments, the identification information comprises at least one index of the at least one service.

In some example embodiments, the identification information comprises a mapping relation of combinations of the group of services and indexes associated with the combinations.

In some example embodiments, the second apparatus further comprises: means for determining the combinations of the group of services and the indexes associated with the combinations; and means for transmit, to the first device, a first message comprising the mapping relation of the combinations and the indexes.

In some example embodiments, the second apparatus further comprises: means for in accordance with a determination that the first index is different from a second index of a combination of the group of services, determining, based on the identification information, at least one of the group of services is unsuccessfully received at the first device; and means for transmitting, to the first device, retransmission of the at least one unsuccessfully received service.

In some example embodiments, the at least one service comprises a first service of the group services, and the HARQ-ACK codebook comprises a HARQ feedback and identification information for the first service.

In some example embodiments, the at least one service comprises a plurality of the services in the group, and the HARQ-ACK codebook comprises a plurality of sub-codebook each comprising HARQ feedback and identification information about one of the plurality of the services.

In some example embodiments, the HARQ-ACK codebook is a Type-2 HARQ-ACK codebook, and the identification information further comprises length information indicating a size of each of the plurality of the sub-codebooks.

In some example embodiments, the length information is determined based on a largest downlink assignment index (DAI) value associated with each of the plurality of the sub-codebooks.

In some example embodiments, the second apparatus further comprises: means for in accordance with a determination that a size of at least one of the plurality of the sub-codebooks is different from a size expected by the second apparatus, determining, based on the identification information, the at least one of the group of services is unsuccessfully received at the first device; and means for transmitting, to the first device, retransmission of the at least one unsuccessfully received service.

In some example embodiments, the first device comprises a terminal device, and the second apparatus comprises a network device.

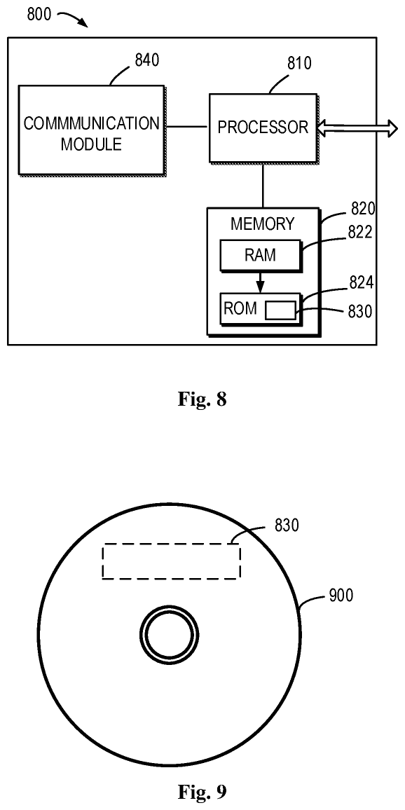

FIG. 8 is a simplified block diagram of a device 800 that is suitable for implementing embodiments of the present disclosure. The device 800 may be provided to implement the communication device, for example the first devices 110 to 112, and the second device 120 as shown in FIG. 1. As shown, the device 800 includes one or more processors 810, one or more memories 840 coupled to the processor 810, and one or more transmitters and/or receivers (TX/RX) 840 coupled to the processor 810.

The TX/RX 840 is for bidirectional communications. The TX/RX 840 has at least one antenna to facilitate communication. The communication interface may represent any interface that is necessary for communication with other network elements.

The processor 810 may be of any type suitable to the local technical network and may include one or more of the following: general purpose computers, special purpose computers, microprocessors, digital signal processors (DSPs) and processors based on multicore processor architecture, as non-limiting examples. The device 800 may have multiple processors, such as an application specific integrated circuit chip that is slaved in time to a clock which synchronizes the main processor.

The memory 820 may include one or more non-volatile memories and one or more volatile memories. Examples of the non-volatile memories include, but are not limited to, a Read Only Memory (ROM) 824, an electrically programmable read only memory (EPROM), a flash memory, a hard disk, a compact disc (CD), a digital video disk (DVD), and other magnetic storage and/or optical storage. Examples of the volatile memories include, but are not limited to, a random access memory (RAM) 822 and other volatile memories that will not last in the power-down duration.

A computer program 830 includes computer executable instructions that are executed by the associated processor 810. The program 830 may be stored in the ROM 820. The processor 810 may perform any suitable actions and processing by loading the program 830 into the RAM 820.

The embodiments of the present disclosure may be implemented by means of the program 830 so that the device 800 may perform any process of the disclosure as discussed with reference to FIGS. 6-7. The embodiments of the present disclosure may also be implemented by hardware or by a combination of software and hardware.

In some embodiments, the program 830 may be tangibly contained in a computer readable medium which may be included in the device 800 (such as in the memory 820) or other storage devices that are accessible by the device 800. The device 800 may load the program 830 from the computer readable medium to the RAM 822 for execution. The computer readable medium may include any types of tangible non-volatile storage, such as ROM, EPROM, a flash memory, a hard disk, CD, DVD, and the like. FIG. 9 shows an example of the computer readable medium 900 in form of CD or DVD. The computer readable medium has the program 830 stored thereon.

Generally, various embodiments of the present disclosure may be implemented in hardware or special purpose circuits, software, logic or any combination thereof. Some aspects may be implemented in hardware, while other aspects may be implemented in firmware or software which may be executed by a controller, microprocessor or other computing device. While various aspects of embodiments of the present disclosure are illustrated and described as block diagrams, flowcharts, or using some other pictorial representations, it is to be understood that the block, device, system, technique or method described herein may be implemented in, as non-limiting examples, hardware, software, firmware, special purpose circuits or logic, general purpose hardware or controller or other computing devices, or some combination thereof.

The present disclosure also provides at least one computer program product tangibly stored on a non-transitory computer readable storage medium. The computer program product includes computer-executable instructions, such as those included in program modules, being executed in a device on a target real or virtual processor, to carry out the methods 600 or 700 as described above with reference to FIG. 6 or 7. Generally, program modules include routines, programs, libraries, objects, classes, components, data structures, or the like that perform particular tasks or implement particular abstract data types. The functionality of the program modules may be combined or split between program modules as desired in various embodiments. Machine-executable instructions for program modules may be executed within a local or distributed device. In a distributed device, program modules may be located in both local and remote storage media.

Program code for carrying out methods of the present disclosure may be written in any combination of one or more programming languages. These program codes may be provided to a processor or controller of a general purpose computer, special purpose computer, or other programmable data processing device, such that the program codes, when executed by the processor or controller, cause the functions/operations specified in the flowcharts and/or block diagrams to be implemented. The program code may execute entirely on a machine, partly on the machine, as a stand-alone software package, partly on the machine and partly on a remote machine or entirely on the remote machine or server.

In the context of the present disclosure, the computer program codes or related data may be carried by any suitable carrier to enable the device, device or processor to perform various processes and operations as described above. Examples of the carrier include a signal, computer readable medium, and the like.

The computer readable medium may be a computer readable signal medium or a computer readable storage medium. A computer readable medium may include but not limited to an electronic, magnetic, optical, electromagnetic, infrared, or semiconductor system, device, or device, or any suitable combination of the foregoing. More specific examples of the computer readable storage medium would include an electrical connection having one or more wires, a portable computer diskette, a hard disk, a random access memory (RAM), a read-only memory (ROM), an erasable programmable read-only memory (EPROM or Flash memory), an optical fiber, a portable compact disc read-only memory (CD-ROM), an optical storage device, a magnetic storage device, or any suitable combination of the foregoing.

Further, while operations are depicted in a particular order, this should not be understood as requiring that such operations be performed in the particular order shown or in sequential order, or that all illustrated operations be performed, to achieve desirable results. In certain circumstances, multitasking and parallel processing may be advantageous. Likewise, while several specific implementation details are contained in the above discussions, these should not be construed as limitations on the scope of the present disclosure, but rather as descriptions of features that may be specific to particular embodiments. Certain features that are described in the context of separate embodiments may also be implemented in combination in a single embodiment. Conversely, various features that are described in the context of a single embodiment may also be implemented in multiple embodiments separately or in any suitable sub-combination.

Although the present disclosure has been described in languages specific to structural features and/or methodological acts, it is to be understood that the present disclosure defined in the appended claims is not necessarily limited to the specific features or acts described above. Rather, the specific features and acts described above are disclosed as example forms of implementing the claims.

1-34. (canceled)

35. An apparatus, comprising:
at least one processor; and
at least one memory including computer program code;
the at least one memory and the computer program code configured to, with the at least one processor, cause the apparatus at least to:
upon receipt of data of at least one of a group of services from a second device, generate a hybrid automatic repeat request acknowledgement (HARQ-ACK) codebook comprising HARQ feedback and identification information for the at least one service, the group of services comprising at least one of multicast and broadcast services (MBSs) and unicast services; and
transmit the HARQ-ACK codebook to the second device.

36. The apparatus of claim 35, wherein the apparatus is further caused to:
receive, from the second device, a first message indicative of identification information for the group of services.

37. The apparatus of claim 35, wherein identification information for the group of services is preconfigured at the apparatus and the second device.

38. The apparatus of claim 35, wherein the identification information comprises at least one of the following:
a preconfigured identifier for the unicast services,
partial or complete cell radio network temporary identities (C-RNTIs) associated with the unicast services, or
partial or complete group RNTIs (G-RNTIs) associated with the MBS services.

39. The apparatus of claim 35, wherein the identification information comprises indexes of the group of services.

40. The apparatus of claim 35, wherein the identification information comprises a mapping relation of combinations of the group of services that the apparatus is interested in and indexes associated with the combinations.

41. The apparatus of claim 40, wherein the apparatus is further caused to:
receive, from the second device, a first message comprising the mapping relation.

42. The apparatus of claim 35, wherein the at least one service comprises a first service of the group services, and the HARQ-ACK codebook comprises a HARQ feedback and identification information for the apparatus.

43. The apparatus of claim 35, wherein the at least one service comprises a plurality of the services in the group, and the HARQ-ACK codebook comprises a plurality of sub-codebooks each comprising HARQ feedback and identification information for one of the plurality of the services.

44. The apparatus of claim 43, wherein the HARQ-ACK codebook is a Type-2 HARQ-ACK codebook, and the identification information further comprises length information for each of the plurality of the sub-codebooks.

45. The apparatus of claim 44, wherein the length information is determined by the apparatus based on a largest downlink assignment index (DAI) value associated with each of the plurality of the sub-codebooks.

46. The apparatus of claim 35, wherein the apparatus is further caused to:
receive, from the second device, retransmission of the previously unsuccessfully received data of at least one of the group of services.

47. The apparatus of claim 35, wherein the apparatus comprises a terminal device, and the second device comprises a network device.

48. An apparatus, comprising:
at least one processor; and
at least one memory including computer program code;
the at least one memory and the computer program code configured to, with the at least one processor, cause the apparatus at least to:
transmit, to a first device, data of a group of services comprising at least one of multicast and broadcast services (MBSs) and unicast services; and
receive, from the first device, a hybrid automatic repeat request acknowledgement (HARQ-ACK) codebook comprising HARQ feedback and identification information for at least one of the group of services.

49. The apparatus of claim 48, wherein the apparatus is further caused to:
transmit, to the first device, a first message indicative of identification information about the group of services.

50. The apparatus of claim 48, wherein the apparatus is further caused to:
determine, based on the identification information, that data of at least one of the group of services is unsuccessfully received at the first device; and
transmit, to the first device, retransmission of the previously unsuccessfully received data of the at least one of the group of services.

51. The apparatus of claim 48, wherein the identification information comprises at least one of the following:
preconfigured identifier for the unicast services,
partial or complete cell radio network temporary identities (C-RNTIs) associated with the unicast services, or
partial or complete group RNTIs (G-RNTIs) associated with the MBS services.

52. The apparatus of claim 48, wherein the identification information comprises a mapping relation of combinations of the group of services that the first device is interested in and indexes associated with the combinations.

53. The apparatus of claim 48, wherein the at least one service comprises a plurality of the services in the group, and the HARQ-ACK codebook comprises a plurality of sub-codebooks each comprising HARQ feedback and identification information about one of the plurality of the services.

54. A method, comprising:
upon receipt of data of at least one of a group of services from a second device, generating, at a first device, a hybrid automatic repeat request acknowledgement (HARQ-ACK) codebook comprising HARQ feedback and identification information for the at least one service, the group of services comprising at least one of multicast and broadcast services (MBSs) and unicast services; and
transmitting the HARQ-ACK codebook to the second device.
